(19) United States
(12) Patent Application Publication
(10) Pub. No.: US 2016/0026327 A1
(43) Pub. Date: Jan. 28, 2016

(54) ELECTRONIC DEVICE AND METHOD FOR CONTROLLING OUTPUT THEREOF

(71) Applicant: Samsung Electronics Co., Ltd., Gyeonggi-do (KR)

(72) Inventors: Hyeju PARK, Seoul (KR); Sanghyuk KOH, Seoul (KR); Yeonhwa OH, Seoul (KR); Sihak JANG, Gyeonggi-do (KR)

(73) Assignee: Samsung Electronics Co., Ltd.

(21) Appl. No.: 14/802,327

(22) Filed: Jul. 17, 2015

(30) Foreign Application Priority Data
Jul. 24, 2014 (KR) 10-2014-0093787

(51) Int. Cl. G06F 3/041; G06F 3/0354; G06F 3/0488; G06F 3/0481

(52) U.S. Cl. CPC G06F 3/0416; G06F 3/0412; G06F 3/04817; G06F 3/03547; G06F 3/03545; G06F 3/0488; G06F 3/04812; G06F 2203/04108

(57) ABSTRACT

An apparatus and method are provided for controlling an output in an electronic device including a touch screen. The method includes receiving a hovering input from a touch input tool over a touch screen; identifying an inclination attribute of the touch input tool providing the hovering input; and providing an output attribute corresponding to the hovering input, based on the identified inclination attribute.

### PRIORITY

This application claims priority under 35 U.S.C. §119(a) to Korean Patent Application Serial No. 10-2014-0093787, which was filed in the Korean Intellectual Property Office on Jul. 24, 2014, the entire disclosure of which is incorporated herein by reference.

### BACKGROUND OF THE INVENTION

1. Field of the Invention

The present invention relates generally to the control of an electronics device, and more particularly, to an electronic device and a method for controlling an output of the electronic device corresponding a touch input provided by a touch input device.

2. Description of the Related Art

An electronic device including a touch screen can receive a touch input, such as a touch gesture or a touch drawing input, generated by a touch input tool, and can provide an output, such as an object selection or a drawing output, in response to the input. The electronic device can detect a direct touch input of the touch input tool, and also detect a hovering input of an approach of the touch input tool within a predetermined distance of the touch screen. Therefore, the electronic device can distinguish between the hovering input and the direct touch input, and variously utilize the different types of inputs generated by the touch input tool.

Generally, the electronic device considers coordinates of a hover input, processes the corresponding hover input, and provides an output corresponding to the hover input. However, while conventional electronic devices can distinguish between a direct touch input and a hovering input, these conventional devices often fail to utilize the hovering input differently than the direct touch input.

### SUMMARY

Accordingly, the present invention is made to address at least the problems and/or disadvantages described above and to provide at least the advantages described below.

An aspect of the present invention is to provide an apparatus and method for controlling an electronic device to vary an output corresponding to a hovering input, based on an inclination attribute of the touch input tool.

In accordance with an aspect of the present invention, a method is provided for controlling an output of an electronic device. The method includes receiving a hovering input from a touch input tool over a touch screen; identifying an inclination attribute of the touch input tool providing the hovering input; and providing an output attribute corresponding to the hovering input, based on the identified inclination attribute.

In accordance with another aspect of the present invention, an electronic device is provided, which includes a touch screen configured to receive an input from a touch input tool and provide an output; and a control unit configured to detect a hovering input from the touch input tool, via the touch screen, to identify an inclination attribute of the touch input tool providing the hovering input, and to provide an output attribute corresponding to the hovering input, based on the identified inclination attribute.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 is a block diagram illustrating a configuration of electronic device according to an embodiment of the present invention;

FIG. 2 is a flowchart illustrating a method for controlling an output of an electronic device according to an embodiment of the present invention;

FIGS. 3A and 3B are screen examples illustrating a method for controlling an output of an electronic device according to an embodiment of the present invention;

FIGS. 4A and 4B are screen examples illustrating a method for controlling an output of an electronic device according to an embodiment of the present invention;

FIGS. 5A and 5B are screen examples illustrating a method for controlling an output of an electronic device according to an embodiment of the present invention;

FIGS. 6A to 6C are screen examples illustrating a method for controlling an output of an electronic device according to an embodiment of the present invention; and

FIGS. 7A to 7C are screen examples illustrating a method for controlling an output of an electronic device according to an embodiment of the present invention.

### DETAILED DESCRIPTION OF EMBODIMENTS OF THE INVENTION

Hereinafter, various embodiments of the present invention are described in detail with reference to the accompanying drawings. The same reference symbols are used throughout the drawings to refer to the same or like parts. Detailed descriptions of well-known functions and structures incorporated herein may be omitted to avoid obscuring the subject matter of the present invention.

Some components in the accompanying drawings are emphasized, omitted, or schematically illustrated, and the size of each component may not fully reflect the actual size. Therefore, the various embodiments of the present invention are not limited to the relative sizes and distances illustrated in the accompanying drawings.

Herein, the expressions “comprise” and “include” indicate the existence of a correspondingly disclosed function, operation, or component, and are not limited to one of an additional function, operation, or component. Further, the terms “include” and “have” indicate that a characteristic, number, step, operation, element, component, or their combination exists, and therefore, it should be understood that the existence or additional possibility of at least one characteristic, number, step, operation, element, component, or their combination is not excluded.

Additionally, the expression “or” includes at least one of the listed items and their combinations. For example, the expression “A or B” may indicate A, B, or both A and B.

Expressions such as “first” and “second” may modify various components of the present invention, but do not limit the corresponding components. For example, the above expressions do not necessarily limit an order and/or importance of the corresponding components, but can be used to merely distinguish a component from another component. For example, both a first user device and a second user device may be the same type of user devices, but indicate separate user devices. For example, within the spirit and scope of the present invention, a first component may be referred to as a second component, and similarly, a second component may be referred to as a first component.

When describing that a component is “connected” to or “accessed” by another component, the component may be directly connected to or accessed by the other component, or another component also may exist between them. However, if a component is described as being “directly connected to” or “directly accessed by” another component, there is no other component that exists therebetween.

It also is to be understood that singular forms “a”, “an”, and “the” include plural referents unless the context dictates otherwise.

Further, unless the context clearly dictates otherwise, all the terms including a technical or scientific term used herein will have the same meaning as generally understood by those skilled in the art. It should be understood that terms defined in a general dictionary have the same meanings as in a related technical context, and are not interpreted as having abnormal or excessively formal meanings unless clearly dictated in the present disclosure.

For example, an electronic device according to an embodiment of the present invention may be a device having a communication function, such as a smartphone, a tablet Personal Computer (PC), a mobile phone, a video phone, an e-book reader, a desktop PC, a laptop PC, a netbook computer, a Personal Digital Assistant (PDA), a Portable Multimedia Player (PMP), an MP3 player, a mobile medical appliance, a camera, or a wearable device such as a head-mounted-device (HMD), electronic clothes, an electronic bracelet, an electronic necklace, an electronic appcessary, an electronic tattoo, or a smartwatch.

Further, an electronic device according to an embodiment of the present invention may be a smart home appliance having a communication function, such as a television (TV), a Digital Video Disk (DVD) player, an audio player, a refrigerator, an air-conditioner, a vacuum cleaner, an oven, a microwave oven, a washing machine, an air cleaner, a set-top box, a media hub (for example, Samsung HomeSync®, Apple TV®, and Google TV®), a game console, an electronic dictionary, an electronic key, a camcorder, and an electronic picture frame.

Additionally, an electronic device according to an embodiment of the present invention may include various medical instruments, such as a Magnetic Resonance Angiography (MRA) device, a Magnetic Resonance Imaging (MRI) device, or a Computed Tomography (CT) device, a camera, an ultrasonic device, a navigation device, a Global Positioning System (GPS) receiver, an Event Data Recorder (EDR), a Flight Data Recorder (FDR), an automobile infotainment device, electronic devices for a ship, such as a navigation device or gyro compass, an electronic avionics device, a security device, and a robot for industry or home.

Further, an electronic device according to an embodiment of the present invention may include at least one of furniture, a building or a part of building, an electronic board, an electronic signature receiving device, a projector, and various measurement devices, e.g., measurement instruments for water supply, electric power, gas supply, or radio waves.

Additionally, an electronic device according to an embodiment of the present invention may be configured by combining any of the above-described various devices.

An electronic device according to an embodiment of the present invention is not limited to the above-described devices.

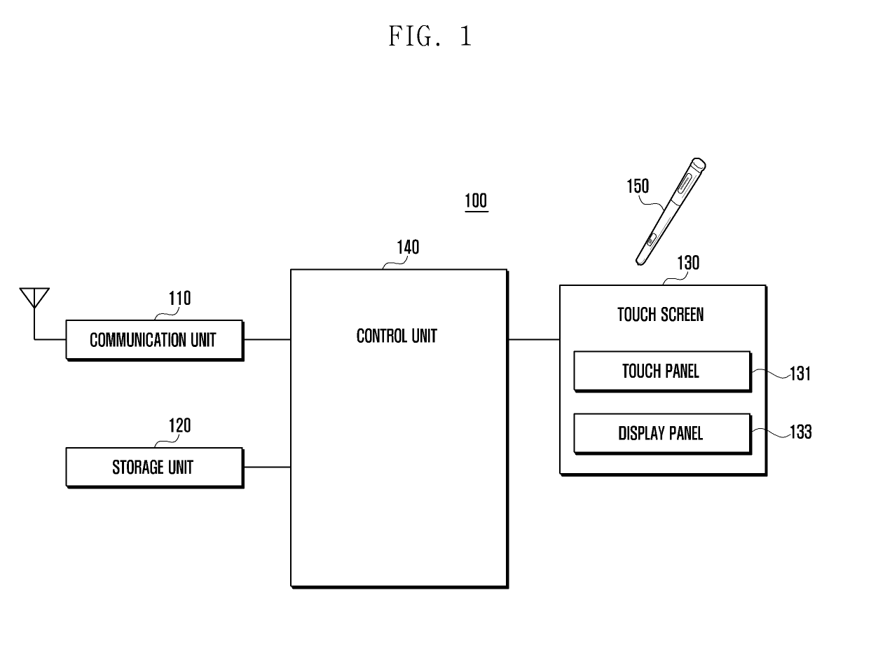

FIG. 1 is a block diagram illustrating a configuration of an electronic device according to an embodiment of the present invention.

Referring to FIG. 1, an electronic device 100 includes a communication unit 110, a storage unit 120, a touch screen 130, a control unit 140, and a touch input tool 150.

The communication unit 110 may provide a communication channel for a connection between the electronic device 100 and an external device or a server. For example, the communication unit 110 may communicate with the external device or server by connecting to a network through wireless or wired communication. Examples of the wireless communication may include Wireless Fidelity (WiFi), Bluetooth (BT), Near Field Communication (NFC), Global Positioning System (GPS), or cellular communication, such as Long Term Evolution (LTE), LTE-Advanced (LTE-A), Code Division Multiple Access (CDMA), Wideband CDMA (WCDMA), Universal Mobile Telecommunications System (UMTS), Wireless Broadband (WiBro), or Global System for Mobile Communications (GSM). Examples of the wired communication may include a Universal Serial Bus (USB), a High Definition Multimedia Interface (HDMI), a Recommended Standard 232 (RS-232), or Plain Old Telephone Service (POTS).

A program area of the storage unit 120 can store an Operating System (OS) for booting the electronic device 100 and operating the above components, and an application for supporting various user functions such as a communication function, a web browser for connecting to an internet server, an MP3 function for playing sound, an image output function for displaying a photo, and a video playing function.

An example of the touch input tool 150 is an electronic pen. Accordingly, the program area can also store a pen input application. The pen input application may include a routine for processing a touch input received by identifying touch input coordinates and inclination attributes of the touch input tool 150.

The inclination attribute of the touch input tool 150 may include an inclination degree and inclination direction of the touch input tool 150. The inclination degree indicates an angle of the touch input tool 150 relative to the touch screen 130, when a touch input is generated on the touch screen 130 using the touch input tool 150. For example, the inclination degree may be an angle of the touch input tool 150 based on the horizontal or vertical plan of the touch screen 130.

For ease of describing the various embodiments of the present invention, the inclination degree is assumed to be 0 when the touch input tool 150 is perpendicular to the touch screen 130. Accordingly, as the touch input tool 150 is tilted towards the touch screen 130, the inclination degree increases.

The inclination direction indicates the direction of the touch input tool 150, when a touch input is generated on the touch screen 130 using the touch input tool 150. For example, plans formed by the touch screen 130 may be divided into left, right, up, and down areas.

According to an embodiment of the present invention, if a user generates a touch input by holding the touch input tool 150 in their right hand, the inclination direction becomes the right side, and if the user generates a touch input by holding the touch input tool 150 in the left hand, the inclination direction becomes the left side.

Further, the inclination attribute of the touch input tool 150 may include an inclination change of the touch input tool 150. For example, the inclination change may include an attribute change at least one of the inclination degree or inclination direction.

The touch screen 130 includes a touch panel 131 and a display panel 133. For example, the touch panel 131 may identify a touch input with at least one of a capacitive, a resistive, an infrared, or an ultrasonic sensor. Further, the touch panel 131 may identify a touch input with an electromagnetic induction sensor.

The control unit 140 controls general operations of the electronic device 100 and signal flows between internal components, performs a data processing function, and controls a power supply from a battery to the components of the electronic device 100.

The control unit 140 may receive a touch input from the touch input tool 150 through the touch screen 130, and generate an output corresponding to the touch input. The control unit 140 may receive a hovering input from the touch input tool 150 through the touch screen 130, and generate an output corresponding to the hovering input. Accordingly, the control unit 140 may generate different outputs for each of the hovering input and the direct touch input, even though the direct touch input and the hover input are identified at the same coordinates. For example, if a direct touch input is identified for a link object, an execution result of a corresponding link may be output. However, if a hovering touch input is identified for the link object, a preview window of contents to be generated by the execution of the corresponding link may be output.

If the hovering input provided by the touch input tool 150 is detected, the control unit 140 identifies an inclination attribute of the touch input tool 150, and outputs an output attribute corresponding to the hovering input, based on the identified inclination attribute.

For example, if a user generates a hovering input by using the touch input tool 150, the control unit 140 can identify an inclination attribute of the touch input tool 150 by using hovering input coordinates and detection coordinates of user's hand. Namely, when the user generates a touch input on the touch screen 130 by using the touch input tool 150, the user's hand can directly touch the touch screen 130. In this case, the control unit 140 can calculate an inclination degree, inclination direction, inclination change, etc., by using the hovering input coordinates, the user's hand touch coordinates, and displacement between the coordinates. For example, the control unit 140 may determine specific coordinates of the user's hand touch as a base point, and calculate a displacement between the base point and the hovering input coordinates. The control unit 140 may identify the inclination information of the touch input tool 150 corresponding to the calculated displacement value by referring to a pre-stored table. For example, the table may store inclination information corresponding to the displacement value.

Alternatively, the control unit 140 may identify the inclination attribute of the touch input tool 150 by using an inclination sensor.

The control unit 140 may change an output attribute corresponding to the hovering input, based on the identified inclination attribute. For example, an output corresponding to a hovering input may the display of a specific object on a screen. The control unit 140 may change the location of the specific object displayed in the screen, based on the inclination attribute of the touch input tool 150.

As another example, if a drawing output is provided, based on the hovering input, the control unit 140 may adjust the thickness of drawing output based on the inclination attribute of the touch input tool 150.

As another example, if a drawing output is provided, based on the hovering input, the control unit 140 may change a display mode of the drawing output, based on the inclination attribute of the touch input tool 150. For example, a display mode of a drawing output may include a pencil mode, a ballpoint pen mode, a brush mode, a highlight mode, etc.

If the inclination attribute changes during the hovering input, the control unit 140 may change the output attribute in real time, by reflecting the change.

Further, the control unit 140 may variously change the output attribute corresponding to the hovering input, based on the inclination attribute of the touch input tool 150.

The touch input tool 150 is a component of the electronic device 100, which can be disconnected from the electronic device 100, and may include a penholder, a pen point formed at an end of the penholder, and a coil for generating a magnetic field, which is disposed in the penholder and adjacent to the pen point. The coil of the touch input tool 150 may form a magnetic field in the vicinity of the pen point. The touch panel 131 may detect the magnetic field formed by the touch input tool 150 and an input generated corresponding to the magnetic field.

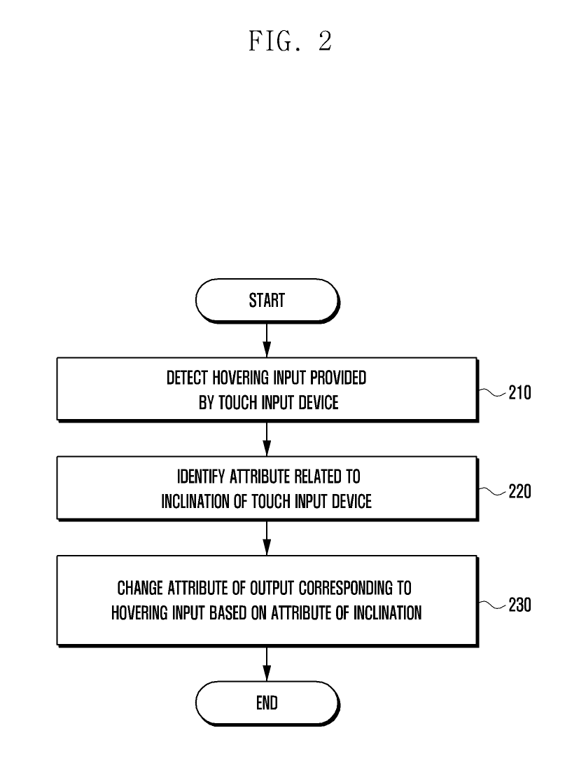

FIG. 2 is a flowchart illustrating a method for controlling an output of an electronic device according to an embodiment of the present invention. Herein, the method illustrated in FIG. 2 will be described with reference to the electronic device 100 illustrated in FIG. 1.

Referring to FIG. 2, the control unit 140 detects a hovering input from the touch input tool 150 through the touch screen 130 in step 210. For example, the control unit 140 may detect the hovering input while executing various application or editing a document.

In step 220, the control unit 140 identifies an inclination attribute of the touch input tool 150 providing the hovering input. As described above, the inclination attribute may include at least one of an inclination degree, an inclination direction, or an inclination change of the touch input tool 150.

In step 230, the control unit 140 generates an output corresponding to the hovering input, and provides an output attribute, based on the inclination attribute. For example, the control unit 140 may determine an output corresponding to a hovering input according to a situation of the electronic device 100 and detection coordinates of the hovering input, while the hovering input is being generated. The control unit 140 may then modify the determined output attribute based on a detected inclination attribute.

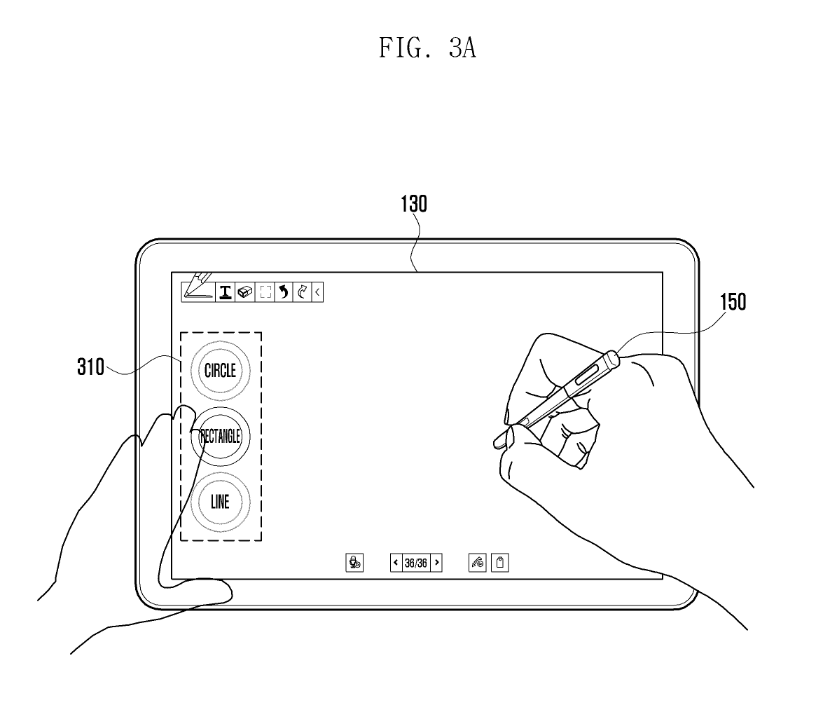

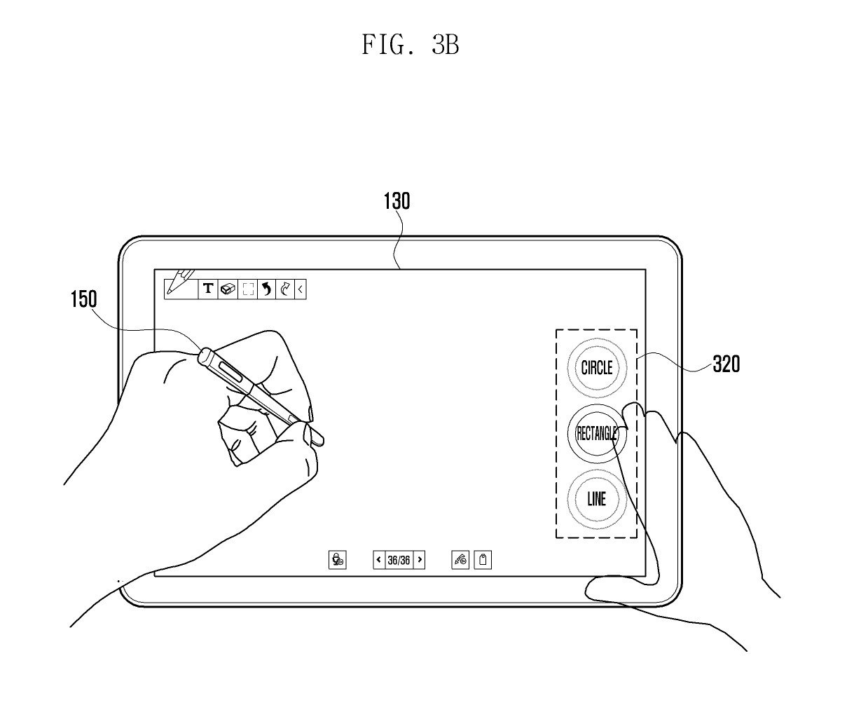

FIGS. 3A and 3B are screen examples illustrating a method for controlling an output of an electronic device according to an embodiment of the present invention. The method illustrated in FIGS. 3A and 3B will be described with reference to the electronic device 100 illustrated in FIG. 1.

In this embodiment, the electronic device 100 executes an application for drawing a picture by using the touch input tool 150. A user may generate a hovering input on the touch screen 130 by holding the touch input tool 150 in the right hand, as illustrated in FIG. 3A, or in the left hand, as illustrated in FIG. 3B.

If the hovering input is detected, the electronic device 100 can output a specific object. For example, if the hovering input is detected, the electronic device 100 can output a menu for supporting a user's drawing operation, such as a figure selection menu 310 or 320, on the touch screen 130.

When a hovering input is generated by holding the touch input tool 150 in the user's right hand, the touch input tool 150 may be identified to be inclined to the right side. Accordingly, the figure selection menu 310 may be displayed in the left area of the touch screen 130, as illustrated in FIG. 3A, so that the touch screen is not covered by the user's right hand and the user's left hand can easily access the figure selection menu 310.

Alternatively, when a hovering input is generated by holding the touch input tool 150 in the user's left hand, the touch input tool 150 may be identified to be inclined to the left side. Accordingly, the figure selection menu 320 may be displayed in the right area of the touch screen 130, as illustrated in FIG. 3B, so that the touch screen is not covered by the user's left hand and the user's right hand can easily access the figure selection menu 320.

Namely, according to the above-described embodiment of the present invention, a location attribute (i.e., left side or right side) of an output corresponding to a hovering input may vary, based on the inclination direction of the touch input tool 150.

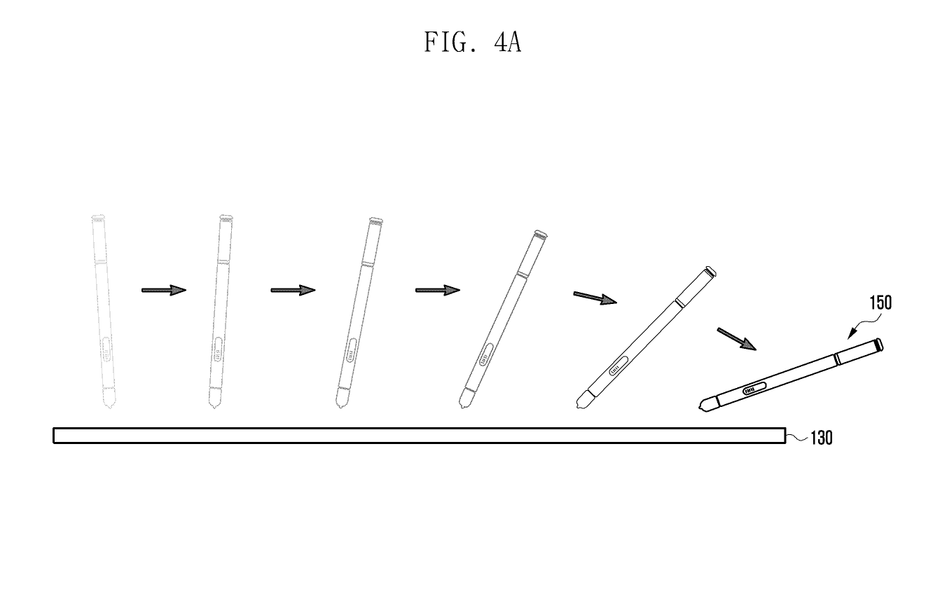

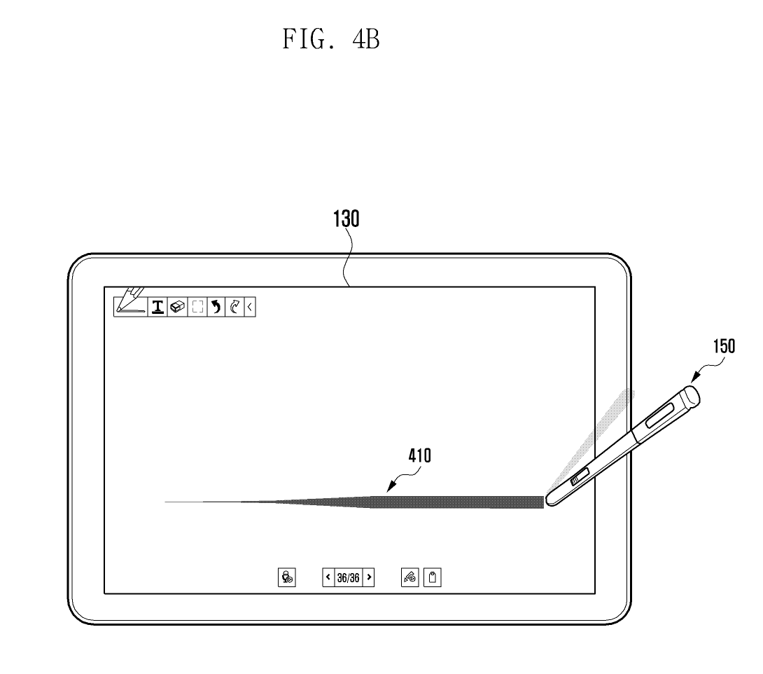

FIGS. 4A and 4B are screen examples illustrating a method for controlling an output of an electronic device according to an embodiment of the present invention. The method illustrated in FIGS. 4A and 4B will be described with reference to the electronic device 100 illustrated in FIG. 1.

In this embodiment, the electronic device 100 executes an application for performing a drawing operation by using the touch input tool 150. A user can generate a continuous hovering input on the touch screen 130 by using the touch input tool 150, as illustrated in FIG. 4A.

In response, the electronic device 100 may display a drawing output 410, on the touch screen 130, corresponding to the hovering input, as illustrated in FIG. 4B.

Further, the electronic device 100 can adjust a thickness attribute of the drawing output 410, by detecting an inclination change of the touch input tool 150 while providing the hovering input.

As illustrated in FIGS. 4A and 4B, the thickness of the drawing output 410 becomes thicker as the inclination degree of the touch input tool 150 increases. For example, the electronic device 100 may adjust the thickness of the drawing output 410 in a proportional, an inversely proportional, or a non-linear form corresponding to the inclination degree of the touch input tool 150.

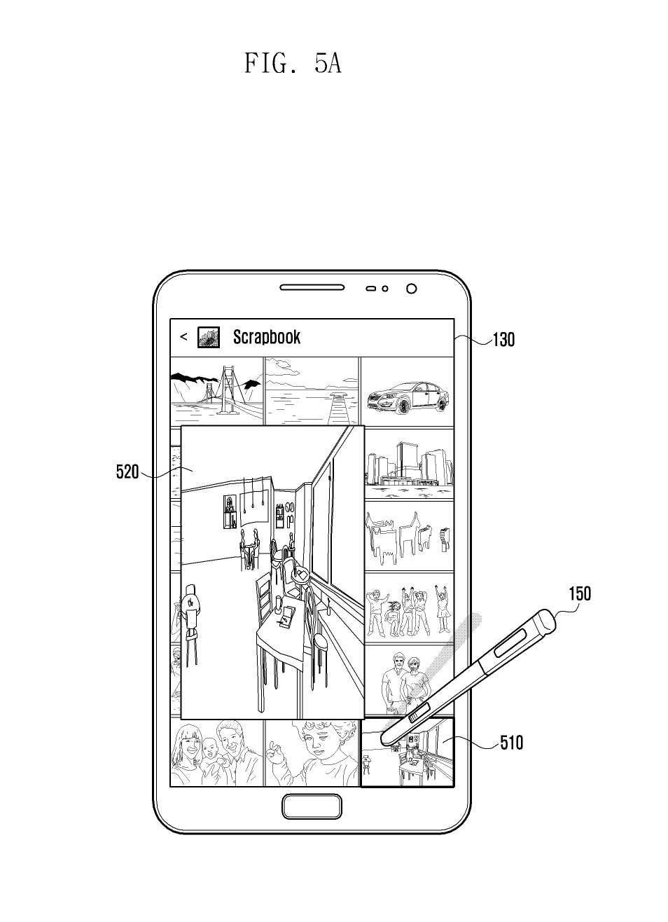

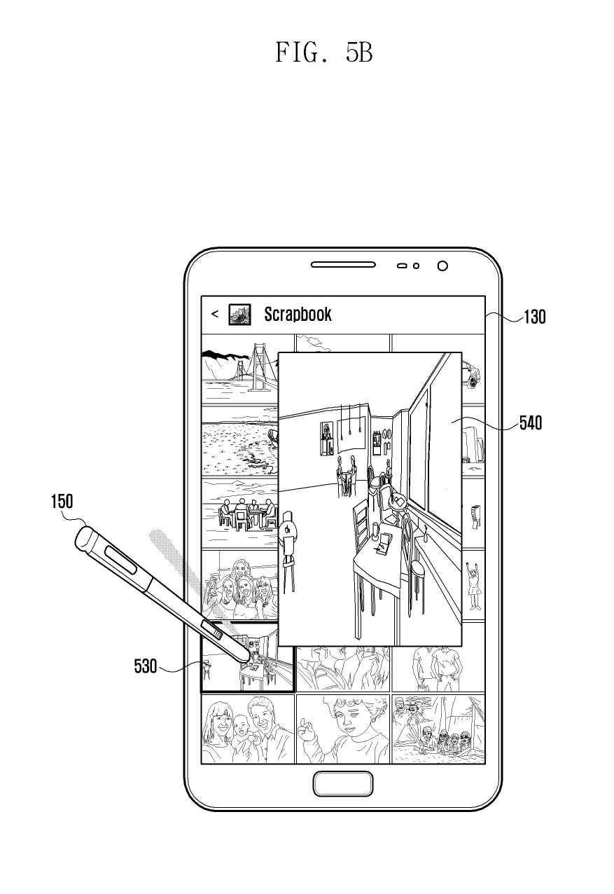

FIGS. 5A and 5B are screen examples illustrating a method for controlling an output of an electronic device according to an embodiment of the present invention. The method illustrated in FIGS. 5A and 5B will be described with reference to the electronic device 100 illustrated in FIG. 1.

In this embodiment, the electronic device 100 executes a photo gallery application. A user can generate a hovering input by using the touch input tool 150 over a photo list displayed on the touch screen 130. For example, the photo list may include a set of images retrieved from stored photos.

Referring to FIGS. 5A and 5B, the user may generate a hovering input over a specific item 510 by holding the touch input tool 150 in the user's right hand, as illustrated in FIG. 5A, or over a specific item 530 by holding the touch input tool 150 in the user's left hand, as illustrated in FIG. 5B.

If the hovering input is detected on item 510 or 530 in the photo list, the electronic device 100 can output a photo corresponding to the item, in a larger size that is more easily identifiable by the user, through a preview window 520 or 540.

When the hovering input is generated by holding the touch input tool 150 in the user's right hand, the touch input tool 150 is identified to be inclined to the right side. Accordingly, the preview window 520 is displayed to the left of the selected item 510, so that the preview window 520 is not covered by the user's right hand, as illustrated in FIG. 5A.

When the hovering input is generated by holding the touch input tool 150 in the user's left hand, the touch input tool 150 is identified to be inclined to the left side. Accordingly, the preview window 540 is displayed to the right of the selected item 530, so that the preview window 540 is not covered by the user's left hand, as illustrated in FIG. 5B.

Namely, according to the above-described embodiment of the present invention, a location attribute of an output corresponding to a hovering input may vary based on the inclination direction of the touch input tool 150.

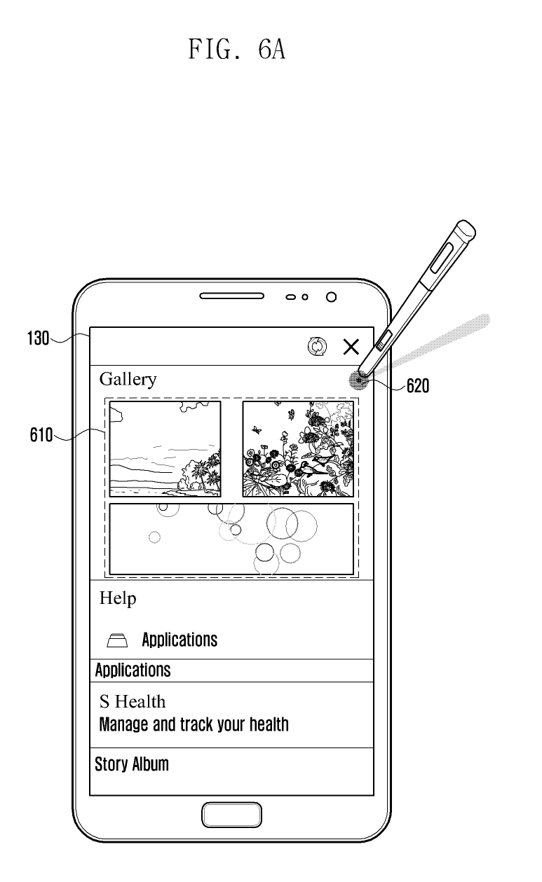

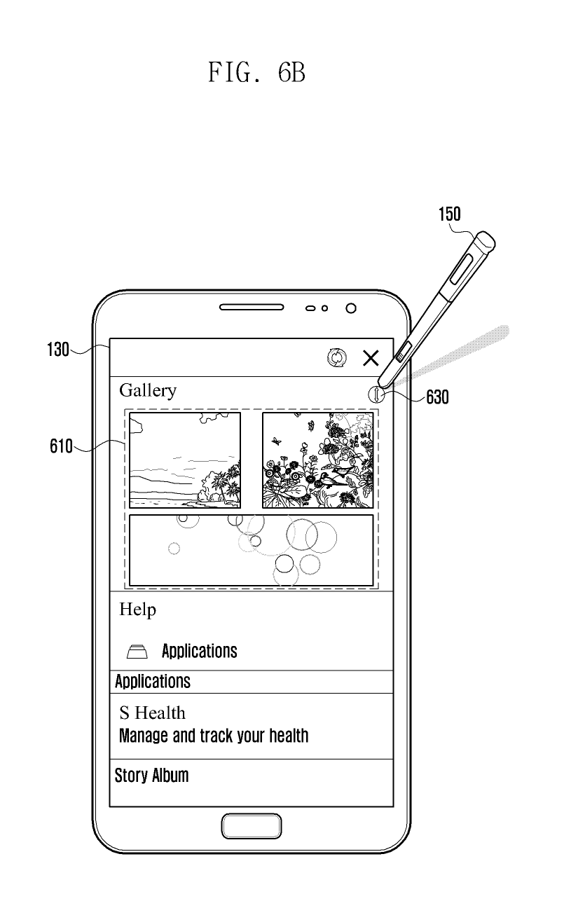

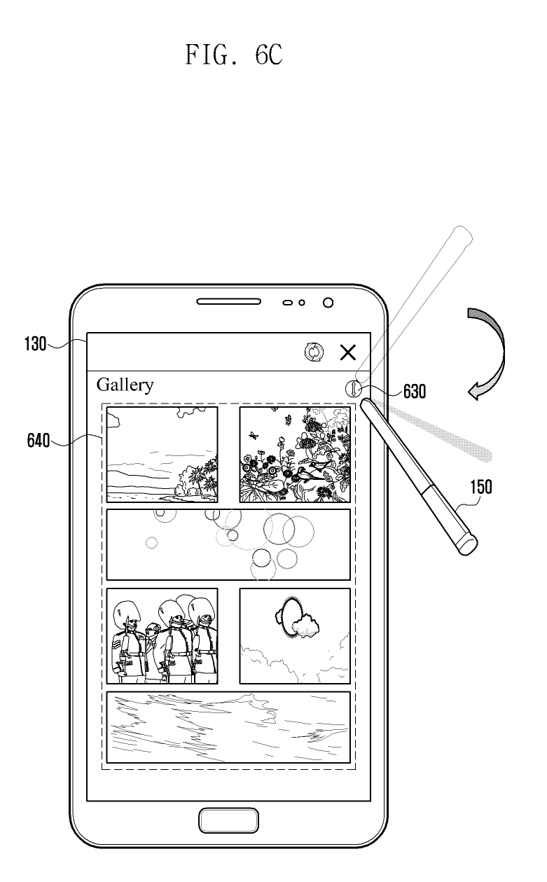

FIGS. 6A to 6C are screen examples illustrating a method for controlling an output of an electronic device according to an embodiment of the present invention. The method illustrated in FIGS. 6A to 6C will be described with reference to the electronic device 100 illustrated in FIG. 1.

In this embodiment, the electronic device 100 executes a photo gallery application. The electronic device 100 displays a photo list area 610 including a photo list and a control icon 620 for controlling the touch screen 130.

Referring to FIG. 6A, a user can generate a hovering input having a substantially identical attribute for the control icon 620 by using the touch input tool 150 for a predetermined time. That is, the user holds the touch input tool 150 in the same position and in the same orientation for the predetermined time.

When the hovering input having a substantially identical attribute is detected for the predetermined time, the electronic device 100 can change the control icon 620 to a modification icon 630, which indicates a possibility of controlling the photo list area 610, as illustrated in FIG. 6B. However, the changing of the icon is an exemplary embodiment, but not essential.

Basically, when the hovering input having the substantially identical attribute is detected for the predetermined time, the electronic device 100 may enter a state for controlling the photo list area 610.

Referring to FIG. 6C, the user can continuously generate the hovering input after the predetermined time, for example, after the control icon 620 is changed to the modification icon 630. Further, the user can change the inclination of the touch input tool 150 during the hovering input, such that the electronic device 100 can extend or contract the range of photo list area 640 by considering the change of inclination degree and inclination direction of the hovering input.

As illustrated in FIG. 6C, if the touch input tool 150 is tilted towards a lower direction, the range of photo list area 640 can be extended to the lower direction, and the degree of extending the photo list area 640 can be decided according to the inclination degree of the touch input tool 150. If the photo list area 640 is extended, an additional photo list can be displayed in the extended area. If the touch input tool 150 is tilted back to being perpendicular to the touch screen 130, the extended photo list area 640 can be restored to the original range.

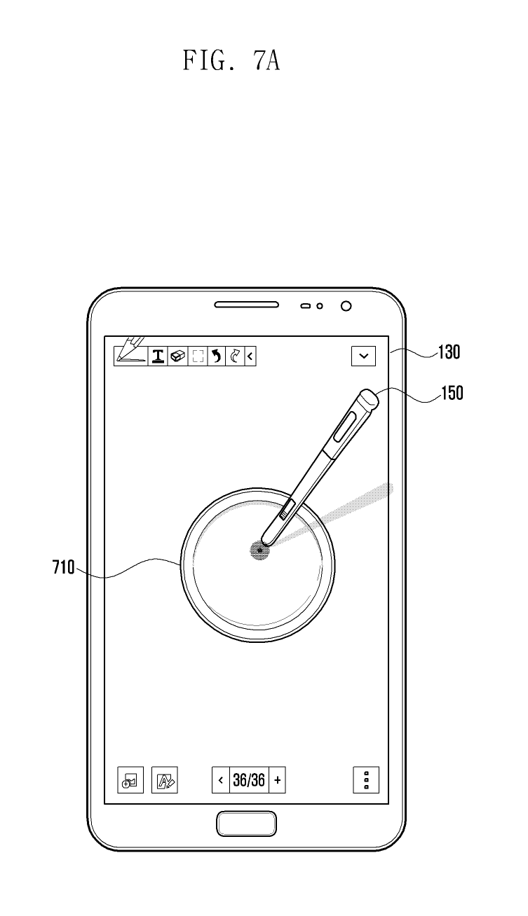

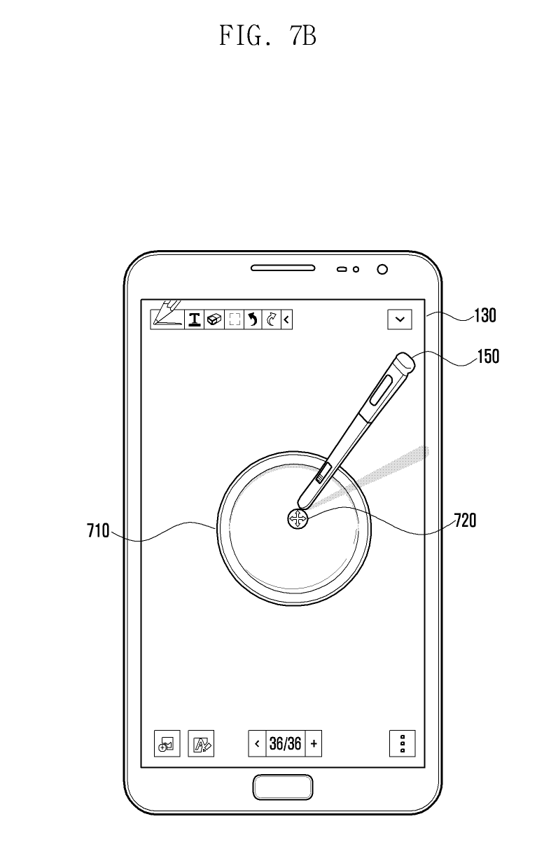

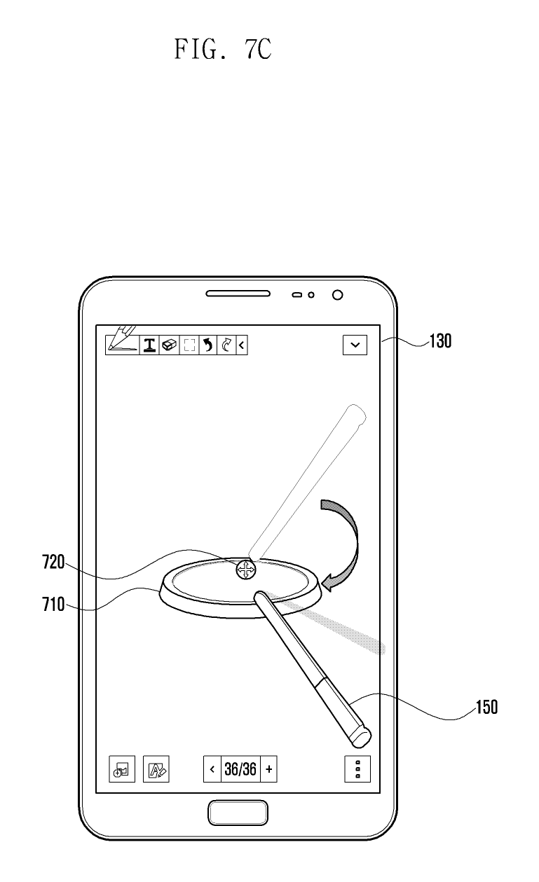

FIGS. 7A to 7C are screen examples illustrating a method for controlling an output of an electronic device according to an embodiment of the present invention. The method illustrated in FIGS. 7A to 7C will be described with reference to the electronic device 100 illustrated in FIG. 1.

In this embodiment, the electronic device 100 executes an image editing application. Specifically, the electronic device 100 displays an object 710 through the touch screen 130.

Referring to FIG. 7A, a user can generate a hovering input having a substantially identical attribute of the object 710 by using the touch input tool 150 for a specific time. That is, the user may hover the touch input tool 150 over the object 710 for the specific period of time. If the hovering input having the substantially identical attribute is detected for the specific time, the electronic device 100 can display a modification icon 720, as illustrated in FIG. 7B. The modification icon 720 may be displayed on the object 710. However, it is noted that the displaying the modification icon 720 is an exemplary embodiment and may not be essential.

If the hovering input having the substantially identical attribute is detected for the specific time, the electronic device 100 enters a state for controlling a movement of the object 710.

Referring to FIG. 7C, the user may continuously generate the hovering input on the object 710 after the specific time, for example, after the modification icon 720 is displayed. Further, the user may change the inclination degree of the touch input tool 150 during the hovering input. For example, the electronic device 100 can rotate the object 710 3-dimensionally, based on the inclination degree and inclination direction of the hovering input.

As illustrated in FIG. 7C, the rotation direction of the object 710 is determined according to the inclination direction, and the rotation degree is determined according to the inclination degree. Accordingly, the object 710 can be rotated in real time according to the inclination change of the touch input tool 150 while providing the hovering input.

At least a portion of a device (for example, electronic device 120 and modules) or a method (for example, operations) according to various embodiments of the present invention can be implemented by a command of programming module form stored in a computer-readable storage media. When the command is executed by more than one processor, the processors can perform a function corresponding to the command. Even though not illustrated in the drawings, the computer-readable storage media may be a storage unit or a memory. At least a portion of the programming module can be implemented by a processor. At least a portion of the programming module may include a module, a program, a routine, a set of instructions, or a process in order to perform at least one function.

The computer-readable storage media may include magnetic media such as a hard disk, a floppy disk, and a magnetic tape, optical media such as a Compact Disc Read Only Memory (CD-ROM) and a DVD, magneto-optical media such as a floptical disk, and hardware devices specially configured to store and execute a program command such as a ROM, a Random Access Memory (RAM), and a flash memory.

Further, the program command may include machine language code generated by a complier and a high-level language code executable by using an interpreter. The aforementioned hardware devices may be configured with at least one software module in order to perform operations according to the present invention.

A module or programming module according to an embodiment of the present invention may include at least one of the above components, and some of the components can be omitted or additional components can be added. The modules, programming module, or operations performed by other components can be implemented serially, parallel, repeatedly, or in a heuristic method. Further, some operations can be performed in a different sequence, omitted, or added by other operations.

A method for controlling an output in an electronic device according to an embodiment of the present invention processes a hovering input by considering an inclination sate of a touch input tool, such that the touch input tool can be more intuitively utilized.

An electronic device according to an embodiment of the present invention varies an output thereof according to an inclination state of a touch input tool, in order to provide an output more appropriately corresponding to a hovering input.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

What is claimed is:

1. A method for controlling an output of electronic device, the method comprising:
receiving a hovering input from a touch input tool over a touch screen;
identifying an inclination attribute of the touch input tool providing the hovering input; and
providing an output attribute corresponding to the hovering input, based on the identified inclination attribute.

2. The method of claim 1, wherein identifying the inclination attribute comprises identifying at least one of an inclination degree, an inclination direction, and an inclination change of the touch input tool.

3. The method of claim 2, wherein providing the output attribute comprises outputting an object on the touch screen corresponding to the hovering input and adjusting an output location of the object, based on the inclination direction of the touch input tool during the hovering input.

4. The method of claim 3, wherein adjusting the output location of the object comprises outputting the object at an opposite side of the inclination direction of the touch input tool during the hovering input.

5. The method of claim 2, wherein providing the output attribute comprises:
displaying a drawing output on the touch screen corresponding to the hovering input; and
adjusting a thickness of the drawing output or modifying a display mode of the drawing output, based on the inclination degree of the touch input tool during the hovering input.

6. The method of claim 5, wherein adjusting the thickness of the drawing output comprises adjusting the thickness of the drawing output proportional or inversely proportional to the inclination degree of the touch input tool during the hovering input, and
wherein modifying the display mode of the drawing output comprises changing the display mode of the drawing output to one of a pencil mode, a ballpoint pen mode, a brush mode, or a highlight mode, based on the inclination degree of the touch input tool during the hovering input.

7. The method of claim 2, wherein receiving the hovering input comprises receiving, for more than a predetermined time, a hovering input over an object displayed in the touch screen.

8. The method of claim 7, wherein providing the attribute output corresponding to the hovering input comprises providing the output attribute corresponding to the inclination change, if the inclination change of the hovering input is detected, after receiving the hovering input over the object for more than the predetermined time.

9. The method of claim 8, wherein providing the output attribute comprises at least one of:
rotating the object 3-dimensionally corresponding to the inclination change; and
re-sizing a specific area displayed on the touch screen corresponding to the inclination change.

10. The method of claim 7, further comprising:
displaying an icon for changing an output through the touch screen, if the hovering input over the object is detected for more than the predetermined time.

11. An electronic device comprising:
a touch screen configured to receive an input from a touch input tool and provide an output; and
a control unit configured to detect a hovering input from the touch input tool, via the touch screen, to identify an inclination attribute of the touch input tool providing the hovering input, and to provide an output attribute corresponding to the hovering input, based on the identified inclination attribute.

12. The electronic device of claim 11, wherein the identified inclination attribute comprises at least one of an inclination degree, an inclination direction, and an inclination change of the touch input tool.

13. The electronic device of claim 12, wherein the control unit provides the output attribute corresponding to the hovering input by outputting an object corresponding to the hovering input on the touch screen and adjusting an output location of the object, based on the inclination direction of the touch input tool during the hovering input.

14. The electronic device of claim 13, wherein the control unit adjusts the output location of the object by outputting the object at an opposite side of the inclination direction of the touch input tool during the hovering input.

15. The electronic device of claim 12, wherein the control unit provides the output attribute corresponding to the hovering input by displaying a drawing output on the touch screen corresponding to the hovering input, and adjusts a thickness of the drawing output or modifies a display mode of the drawing output, based on the inclination degree of the touch input tool during the hovering input.

16. The electronic device of claim 15, wherein the control unit adjusts the thickness of the drawing output proportional or inversely proportional to the inclination degree of the touch input tool during the hovering input, and changes the display mode of the drawing output to one of a pencil mode, a ballpoint pen mode, a brush mode, or a highlight mode, based on the inclination degree of the touch input tool during the hovering input.

17. The electronic device of claim 12, wherein the control unit receives the hovering input by receiving, for more than a predetermined time, a hovering input over an object displayed on the touch screen.

18. The electronic device of claim 17, wherein the control unit provides the attribute output corresponding to the hovering input by providing an output attribute corresponding to the inclination change, if the inclination change of the hovering input is detected, after receiving the hovering input over the object for more than the predetermined time.

19. The electronic device of claim 18, wherein the control unit is further configured to rotate the object 3-dimensionally corresponding to the inclination change, or re-size a specific area displayed on the touch screen, corresponding to the inclination change.

20. The electronic device of claim 17, wherein the control unit is further configured to display an icon for changing an output through the touch screen, if the hovering input over the object is detected for more than the predetermined time.
